(19) United States
(12) Patent Application Publication
(10) Pub. No.: US 2015/0029423 A1
(43) Pub. Date: Jan. 29, 2015

(54) TOUCH PANEL

(71) Applicant: WINTEK CORPORATION, Taichung City (TW)

(72) Inventors: Cheng-Chieh Huang, Yilan City (TW); Kuo-Hsing Chen, New Taipei City (TW); Chung-Hsien Li, Taichung City (TW); Kuo-Chang Su, Taichung City (TW); Chun-Cheng Lu, Taichung City (TW); Chen-Hao Su, Taichung City (TW); Yu-Ting Chen, Pingzhen City (TW)

(21) Appl. No.: 14/445,128

(22) Filed: Jul. 29, 2014

(30) Foreign Application Priority Data
Jul. 29, 2013 (TW) 102127184

(51) Int. Cl. G02F 1/1333; G06F 3/047

(52) U.S. Cl. CPC G02F 1/13338; G06F 3/047; G06F 2203/04112
USPC 349/12

(57) ABSTRACT

A touch panel is provided. The touch panel includes multiple sensing units, multiple connecting wires and multiple bridge wires. A part of the sensing units are arranged along a first direction, and another part of the sensing units are arranged along a second direction. A part of the connecting wires and a part of the bridge wires are connected to the part of the sensing units along the first direction. Another part of connecting wires and another part of bridge wires are connected to the another part of the sensing units along the second direction. The impedance value of each bridge wire is different from that of each connecting wire.

This application claims the benefit of Taiwan application Serial No. 102127184, filed Jul. 29, 2013, the subject matter of which is incorporated herein by reference.

### BACKGROUND OF THE INVENTION

1. Field of the Invention

The invention relates in general to a panel, and more particularly to a touch panel.

2. Description of the Related Art

Touch panels are developed along with the advancement of technologies. A user may enter an input signal by directly selecting a point on a touch panel or entering texts on a touch panel. The intuitive input function offered by touch panels is considered as a revolutionary technique. Therefore, touch panels are widely applied in diversified electronic products.

In a touch panel, a touch position of a user is sensed by sensing units distributed on the touch panel. Preferably, the impedance matching of a touch panel needs to reach a balance, so that sensing units are allowed to more accurately obtain signals.

### SUMMARY OF THE INVENTION

The invention is directed to a touch panel that adjusts the impedance matching of the touch panel through designs and arrangements of bridge wires and connecting wires.

According to an aspect of the present invention, a touch panel is provided. The touch panel includes multiple sensing units, multiple connecting wires and multiple bridge wires. A part of the sensing units are arranged along a first direction, and another part of the sensing units are arranged along a second direction. A part of the connecting wires and a part of the bridge wires are connected to the part of the sensing units along the first direction. Another part of the connecting wires and another part of the bridge wires are connected to the another part of the sensing units along the second direction. The impedance value of each bridge wire is different from that of each connecting wire.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a touch panel according to an embodiment of the present invention;

FIG. 2 is an enlarged view of a dotted region C1 in FIG. 1;

FIG. 3 is a sectional view along a section line 3-3 in FIG. 2;

FIG. 4 is a schematic diagram of a touch panel according to another embodiment of the present invention;

FIG. 5 is an enlarged view of a dotted region C2 in FIG. 4;

FIG. 6 is a sectional view along a section line 6-6 in FIG. 5;

FIG. 7 is a schematic diagram of a touch panel according to another embodiment of the present invention;

FIG. 8 is a schematic diagram of a touch panel according to another embodiment of the present invention;

FIG. 9 is a schematic diagram of a touch panel according to another embodiment of the present invention;

FIG. 10 is a schematic diagram of a touch panel according to another embodiment of the present invention;

FIG. 11 is a schematic diagram of a touch panel according to another embodiment of the present invention;

FIG. 12 is a schematic diagram of a touch panel according to another embodiment of the present invention;

FIG. 13 is a schematic diagram of a touch panel according to another embodiment of the present invention;

FIG. 14 is a schematic diagram of a touch panel according to another embodiment of the present invention;

FIG. 15 is a schematic diagram of a touch panel according to another embodiment of the present invention; and

FIG. 16 is a schematic diagram of a touch panel according to another embodiment of the present invention.

### DETAILED DESCRIPTION OF THE INVENTION

In the various embodiments given below, the impedance matching of a touch panel is adjusted through designs and arrangements of bridge wires and connecting wires. It should be noted that the embodiments are examples for explaining the present invention, not limiting the present invention. In the drawings for illustrating the embodiments, some components are omitted to better understand technical characteristics of the present invention.

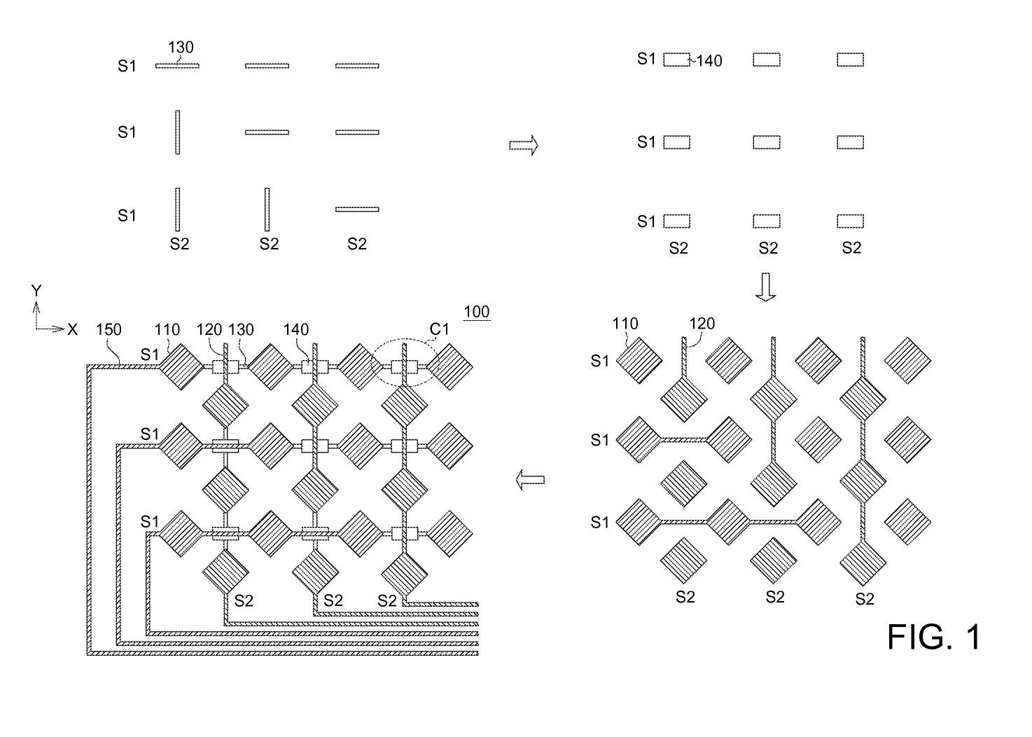

FIG. 1 shows a schematic diagram of a touch panel 100 according to an embodiment of the present invention. The touch panel 100 includes a plurality of sensing units 110, a plurality of connecting wires 120, a plurality of bridge wires 130, a plurality of insulating layers 140 and a plurality of lead wires 150. The sensing units 110, the connecting wires 120, the bridge wires 130, the insulating layers 140 and the lead wires 150 are disposed on a substrate, and are located at the same side of the substrate. For example, the substrate is a cover lens including a decorative layer, or a component (e.g., substrate) of a display device (e.g., an OLED display or an LCD display), such as a color filter (CF) of an LCD display or an encapsulation cover of an OLED display. The connecting wires 120 and the bridge wires 130 are for connecting neighboring sensing units 110. The lead wires 150 are for electrically connecting the outermost sensing units 110 and pads, so as to transmit sensing signals to a circuit board connected to the pads. For example, the sensing units 110, the connecting wires 120 and the bridge wires 130 are made of a transparent conductive material, such as indium tin oxide (ITO) or indium zinc oxide (IZO). Alternatively, the sensing units 110, the connecting wires 120 and the bridge wires 130 may also be made of a non-transparent material that is non-obvious to the naked eye, such as a thin metal layer, nano silver wire or a metal mesh. In the embodiment, the connecting wires 120 and the sensing units 110 are made of the same material, and are simultaneously formed in the same process, i.e., the connecting wires 120 and the sensing units 110 are formed integrally. Alternatively, the connecting wires 120 and the sensing units 110 may also be made of different materials, and be manufactured separately in different processes. Although the material of the connecting wires 120 is the same as that of the bridge wires 130, the impedance value of the bridge wires 130 may be different from that of the connecting wires 120 due to variations in processes and/or sizes (including length, width and height). In the embodiment, the connecting wires 120 and the bridge wires 130 are made of the same material, and the impedance value of the bridge wires 130 is lower than that of the connecting wires 120 due to different process temperatures and different sizes. In an alternative embodiment, the impedance values may be rendered different through either different sizes or different process conditions. In yet another embodiment, different impedance values may also be directly achieved by adopting different materials. It should be noted that, even with different materials, it is possible that final impedance values would be the same due to different sizes. The insulating layers 140 are for electrically insulating circuits S1 and circuits S2 along different directions. For example, the insulating layers 140 may be made of an inorganic material such as silicon oxide, or an organic material such as photoresist.

As shown in FIG. 1, the components are sequentially stacked according to the order of the arrows. In the upper-left diagram, the bridge wires 130 are arranged at predetermined positions. In the second diagram, the insulating layers 140 are disposed on the bridge wires 130, so that the circuits S1 and the circuits S2 are kept electrically insulated along different directions when subsequently stacking the components. In the third diagram, the sensing units 110 and the connecting wires 120 are arranged at predetermined positions. In the fourth diagram, the lead wires 150 that connect to the sensing units 110 are disposed.

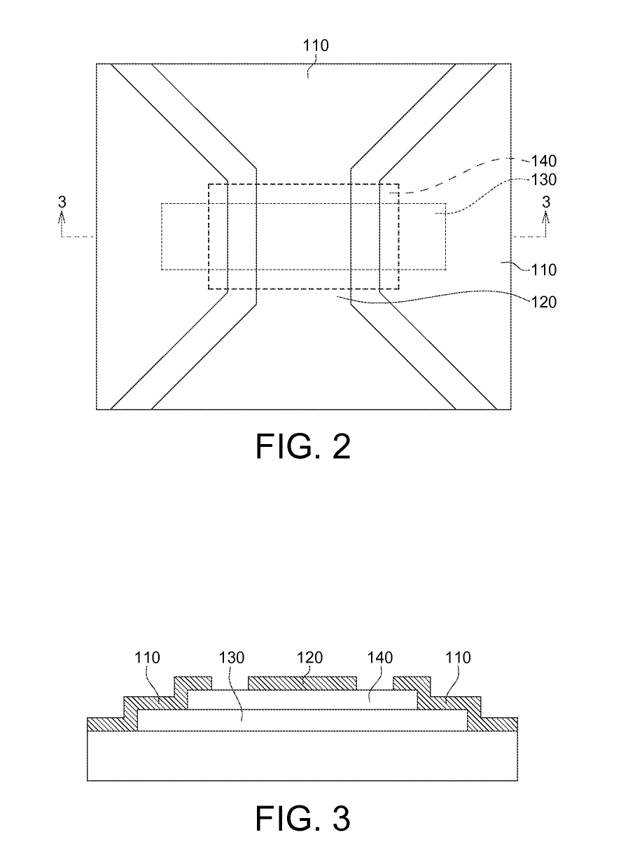

FIG. 2 shows an enlarged view of a dotted region C1 in FIG. 1. FIG. 3 shows a sectional view along a section line 3-3 in FIG. 2. The bridge wires 130, the insulating layers 140 and the connecting wires 120 are stacked in the dotted region C1. The stacking relationship can be observed from FIGS. 2 and 3. The bridge wires 130 are located at a lowermost part, the insulating layers 140 are stacked on the bridge wires 130, and the connecting wires 120 and the sensing units 110 are disposed on the insulating layers 140 and the bridge wires 130. As shown in FIG. 3, the left sensing units 110 are electrically connected to the right sensing units 110 via the bridge wires 130 under the insulating layer 140. The bridge wires 130 are electrically insulated from the connecting wires 120 via the insulating layers 140.

As shown in the lower-left diagram in FIG. 1, a part of the sensing units 110 are arranged along a first direction (e.g., a plurality of straight lines parallel to the X-axis), and a part of the sensing units 110 are arranged along a second direction (e.g., a plurality of straight lines parallel to the Y-axis). The first direction is substantially perpendicular to the second direction. That is to say, the sensing units 110 are in a matrix arrangement along two axial directions, such that coordinates of a touch position can be obtained when the touch panel 100 is touched.

As shown in the lower-left diagram in FIG. 1, a part of the connecting wires 120 and a part of the bridge wires 130 are connected to a part of the sensing units 110 along the first direction to form the circuits S1. Another part of the connecting wires 120 and another part of the bridge wires 130 are connected to another part of the sensing units 110 along the second direction to form the circuits S2. In the embodiment, the sensing units 110 along the first direction are not entirely connected via the connecting wires 120 and are not entirely connected via the bridge wires 130. Similarly, the sensing units 110 along the second direction are not entirely connected via the connecting wires 120 and are not entirely connected via the bridge wires 130.

For example, to improve the impedance difference of the lead wires 150, the bridge wires 130 having low impedance are interweaved in the circuits S1 and S2. More specifically, the quantities of the bridge wire 130 in the circuits S1 and S2 are different, such that the different circuits S1 and S2 are given with similar impedance values compared to original impedance values. The circuits S1 and S2 originally having higher impedance values may be connected by a greater number of bridge wires 130, whereas the circuits S1 and S2 originally having lower impedance values may be connected by a smaller number of low-impedance bridge wires 130, thereby achieving similar overall impedance for the touch panel 100.

Referring to FIG. 1, from top to bottom, the length of the lead wires 150 of the first circuit S1 for connecting a pad connected to an external component is the longest, and so the first circuit S1 may be connected by using three low-impedance bridge wires 130, the second circuit S1 is connected by using two low-impedance bridge wires 130, and the third circuit S1 is connected by one low-impedance bridge wire 130, such that the impedance differences of all of the circuits S1 are reduced.

As shown in FIG. 1, from left to right, the length of the lead wire 150 of the first circuit S2 for connecting a pad connected to an external component is the longest, and so the first circuit S2 may be connected by using two low-impedance bridge wires 130, the second circuit S2 may be connected by one low-impedance bridge wire 130, and the third circuit S3 is not connected by any bridge wire 130, such that the impedance differences of all of the circuits S2 are reduced.

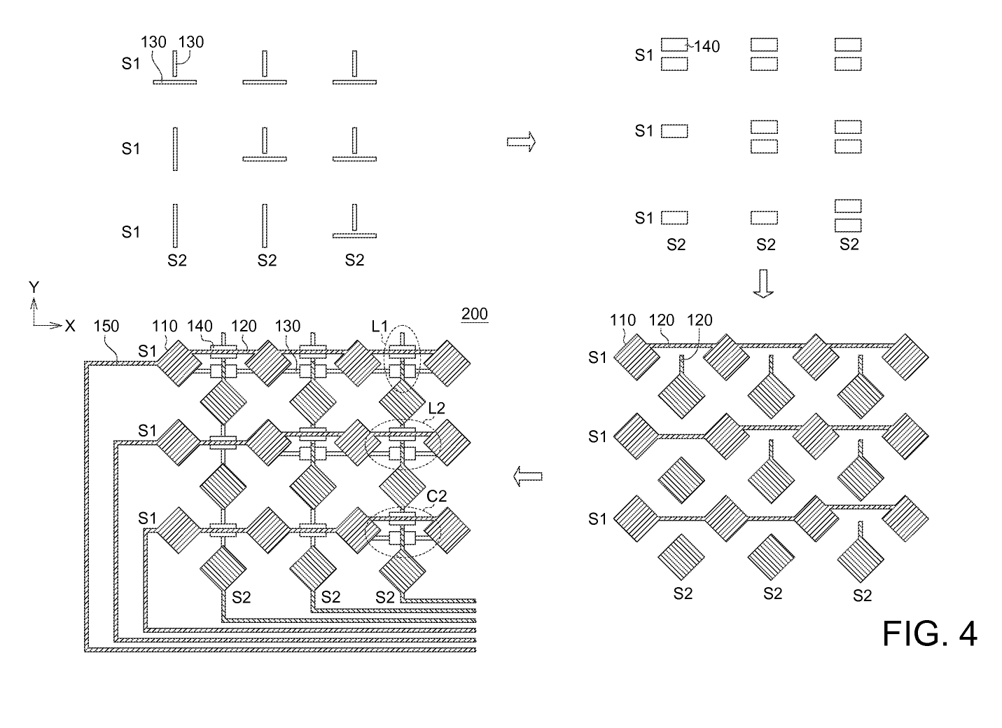

FIG. 4 shows a schematic diagram of a touch panel 200 according to another embodiment of the present invention. A main difference between the touch panel 200 in FIG. 4 and the touch panel 100 in FIG. 1 is the designs of the connecting wires 120 and the bridge wires 130, and other similarities are omitted herein.

As shown in the upper-left diagram in FIG. 4, the length of a part of the bridge wires 130 is smaller than that of another part of the bridge wires 130. For example, the length of a part of the bridge wires 130 is substantially 1/2 of the length of another part of the bridge wires 130.

Taking the third diagram from the left in FIG. 4 for example, the length of a part of the connecting wires 120 is smaller than that of another part of the connecting wires 120. For example, the length of a part of the connecting wires 120 is substantially 1/2 of the length of another part of the connecting wires 120.

As shown in the lower-left diagram in FIG.4, the short connecting wires 120 and the short bridge wires 130 are connected in series to form single-wire structures L1 for connecting to the neighboring sensing units 110.

As shown in the lower-left diagram in FIG.4, the long connecting wires 120 and the long bridge wires 130 are arranged into dual-line structures L2 for connecting to the neighboring sensing units 110.

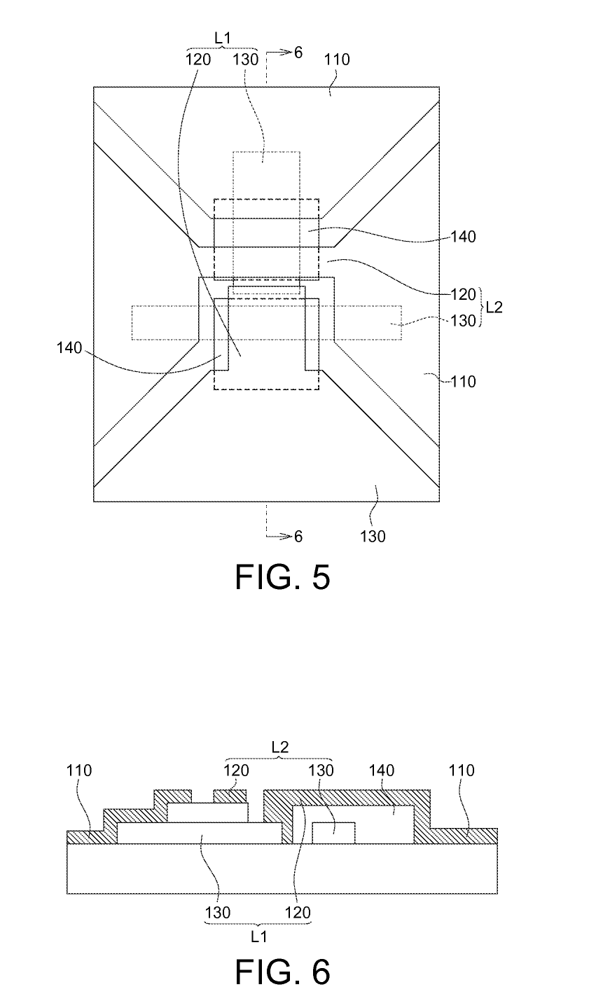

FIG. 5 shows an enlarged view of a dotted region C2 in FIG. 4. FIG. 6 shows a sectional view along a section line 6-6 in FIG. 5. In the embodiment, the bridge wires 130, the insulating wires 140 and the connecting wires 120 are stacked to form single-line structures L1 and dual-line structures L2. Referring to FIGS. 5 and 6, the stacking relationship of the single-line structures L1 and the dual-line structures L2 can be observed. The bridge wires 130 are located at a lowermost part, the insulating layers 140 are stacked on the bridge wires 130, and the connecting wires 120 and the sensing units 110 are disposed on the insulating layers 140 and the bridge wires 130. As shown in FIG. 6, via the left bridge wires 130 under the insulating layers 140, the left sensing units 110 are electrically connected to the right connecting wires 120 covering on the insulating layers 140 to form the single-line structure L1. The left connecting wires 120 on the insulating layers 140 and the right bridge wires 130 under the insulating layers 140 form the dual-line structure L2.

As shown in FIG. 4, from top to bottom, the length of the lead wire 150 of the first circuit S1 for connecting the pad is the longest, and so the first circuit S1 may be connected by using three bridge wires 130, the second circuit S1 is connected by using two bridge wires 130, and the third circuit S1 is connected by using one bridge wire 130, such that the impedance differences of all of the circuits S1 are reduced.

As shown in FIG. 4, from left to right, the length of the lead wire 150 of the first circuit S2 for connecting the pad is the longest, and so the first circuit S2 may be connected by using two longer bridge wires 130 and one shorter bridge wire 130, and the second circuit S2 is connected by using one longer bridge wire 130 and two shorter bridge wires 130, and the third circuit S2 is connected by using three shorter bridge wires 130, such that the impedance differences of all of the circuits S2 are reduced.

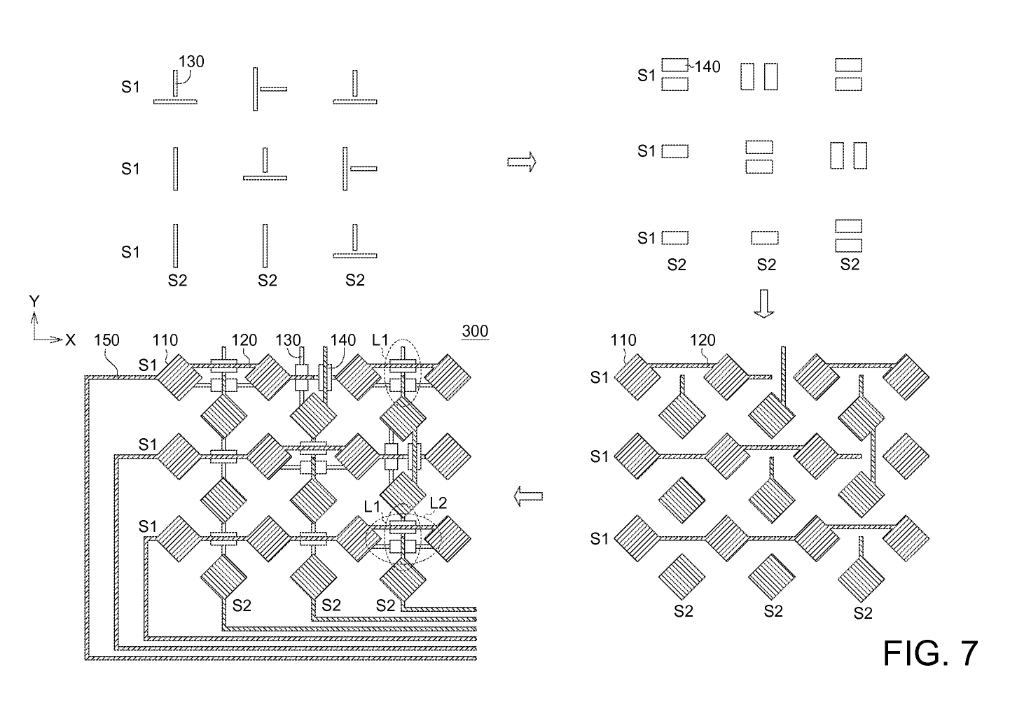

FIG. 7 shows a schematic diagram of a touch panel 300 according to another embodiment of the present invention. A main difference between the touch panel in FIG. 7 and the touch panel 200 in FIG. 4 is the arrangement of the dual-line structures L2, and other similarities are omitted herein.

As shown in FIG. 7, the dual-line structures L2 may not only be disposed on the circuits S1, but also be disposed on the circuits S2 to reduce the impedance differences of all of the circuits S2. In the embodiment, the dual-line structures L2 are staggered on the circuits S1 or the circuits S2 to balance the overall impedance. For example, for positions with higher impedance, a larger number of dual-line structures L2 may be arranged; for positions with lower impedance, a larger number of single-line structures L1 may be arranged. At an intersection where one circuit S1 staggers one circuit S2 (a position denoted both L1 and L2 in FIG. 7), the single-line structure L1 is disposed on the circuit S2 and the dual-line structure L2 is disposed on the circuit S1. Staggering the dual-line structures L2 on the circuits S1 or the circuits S2 is in equivalent to staggering the single-line structures L1 on the circuits S1 or the circuits S2, such that the overall impedance can be balanced.

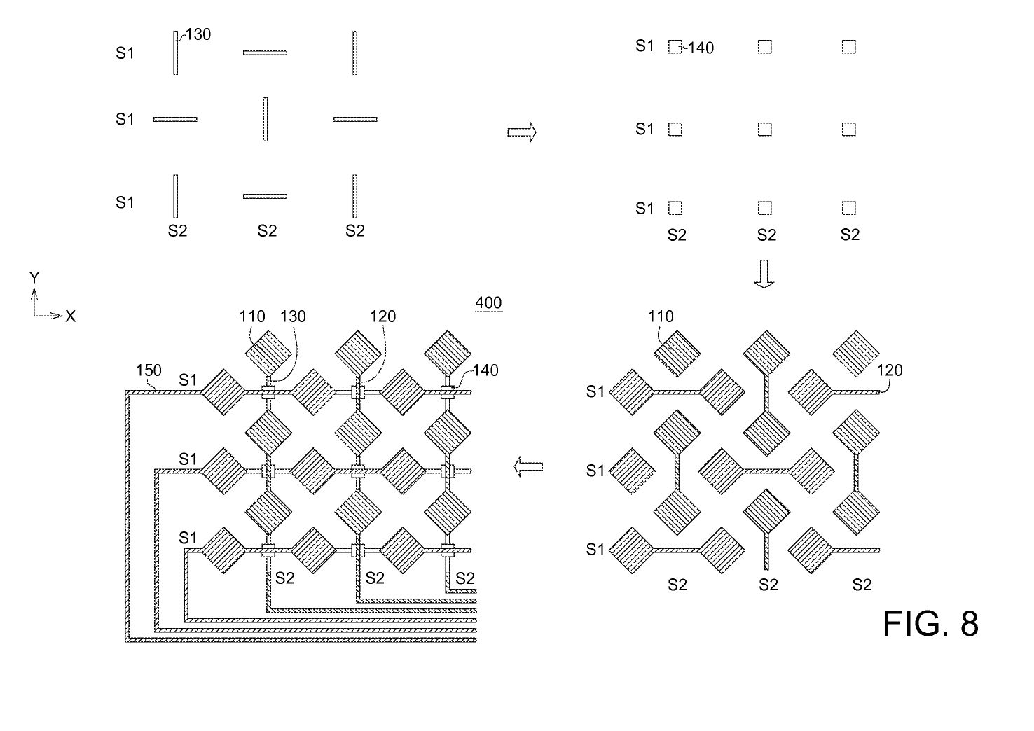

FIG. 8 shows a schematic diagram of a touch panel 400 according to another embodiment of the present invention. A main difference between the touch panel 400 in FIG. 8 and the touch panel 100 in FIG. 1 is the arrangements of the bridge wires 130 and the connecting wires 120, and other similarities are omitted herein.

As shown in FIG. 8, the quantities of the bridge wires 130 in each of the circuits S1 and S2 are the same to provide better uniformity. The bridge wires 130 may be arranged in a knitting layout to achieve balanced impedance matching. That is to say, the bridge wires 103 are staggered on the circuits S1 or the circuits S2. More specifically, two neighboring bridge wires 130 are extended toward different directions. In the embodiment, two neighboring bridge wires 130 are respectively extended toward the first direction and the second direction, as an example. Meanwhile, the connecting wires 120 are also staggered on the circuits S1 or the circuits S2. As such, the impedance differences of the circuits S1 and the circuits S2 can be reduced.

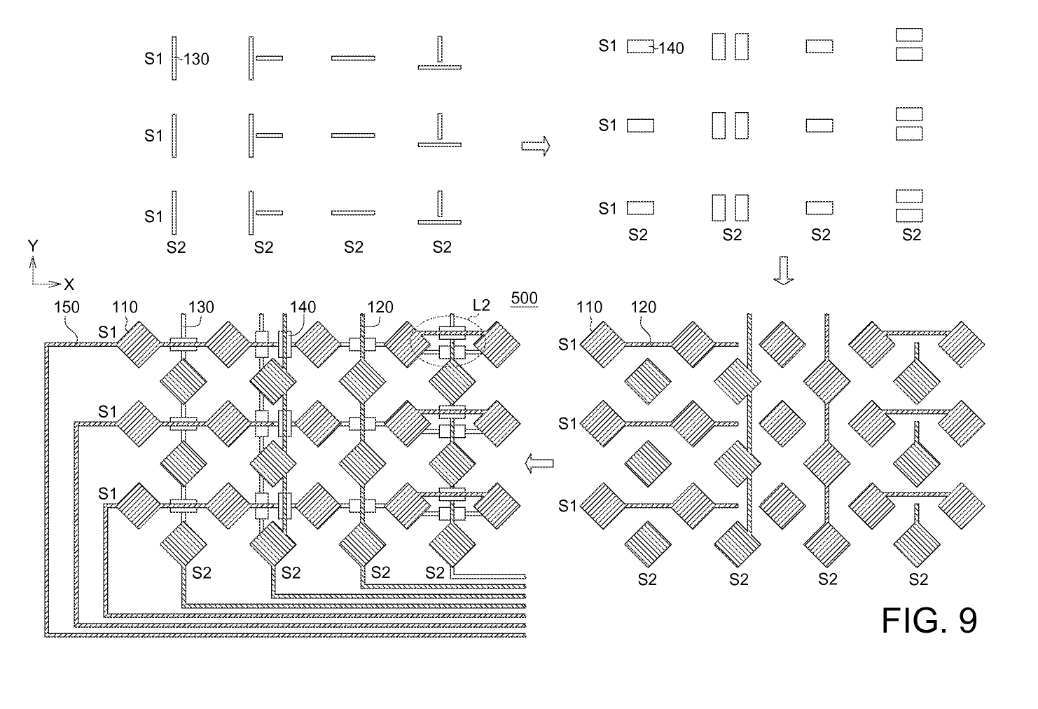

FIG. 9 shows a schematic diagram of a touch panel 500 according to another embodiment of the present invention. A main difference between the touch panel 500 in FIG. 9 and the touch panel 200 in FIG. 4 is the arrangement of the dual-line structures L2, and other similarities are omitted herein.

In the circuits S1, at a position with higher impedance, the dual-line structure L2 may be arranged. As shown in FIG. 9, to improve the impedance difference between a start position where the sensing unit 110 connected to the lead wire 150 is located and an end position where the sensing unit 110 located farthest from the lead wire 150 in the same row is located, the dual-structure L2 may be arranged at the end position of the circuits S1 to provide the circuits S1 with uniform impedance.

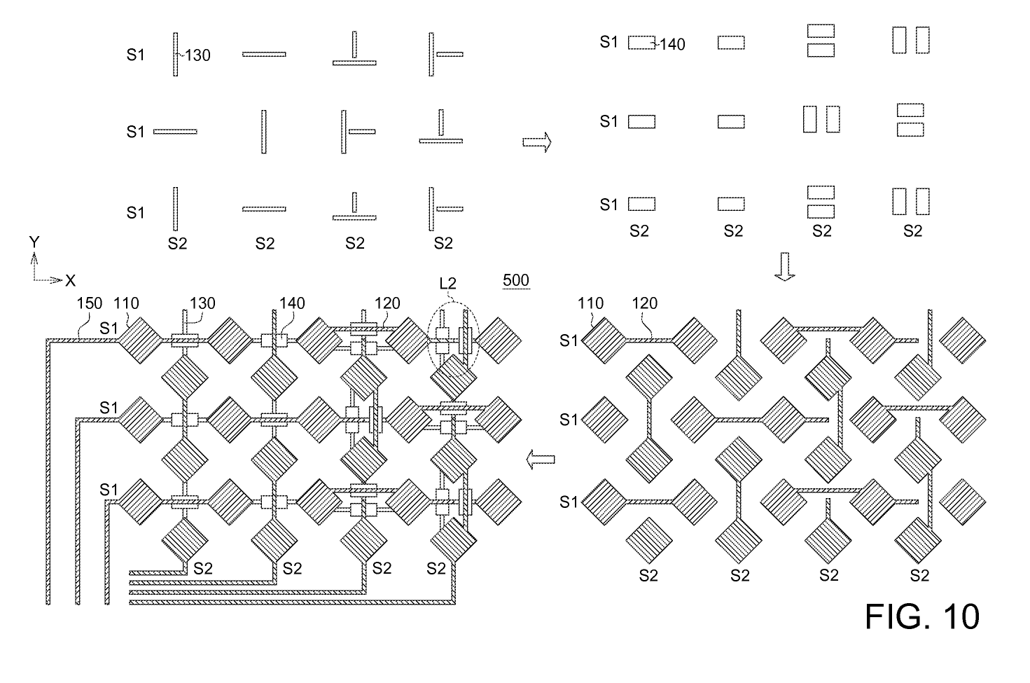

FIG. 10 shows a schematic diagram of a touch panel 600 according to another embodiment of the present invention. A main difference between the touch panel 600 in FIG. 10 and the touch panel 500 in FIG. 9 is the arrangement of the dual-line structures L2, and other similarities are omitted herein.

As shown in FIG. 10, to improve the impedance difference between the start position and the end position of the circuits S1, the dual-line structure L2 may be arranged at the end position of the circuits S1 to provide the circuits S1 with uniform impedance. Further, the quantities of the dual-line structures L2 of the circuits S1 and the circuits S2 may be the same to yield better uniformity. The dual-line structures L2 may be arranged in a knitting layout to achieve an impedance matching balance. That is to say, the dual-line structures L2 are staggered on the circuits S1 or the circuits S2 to achieve a balance in overall impedance.

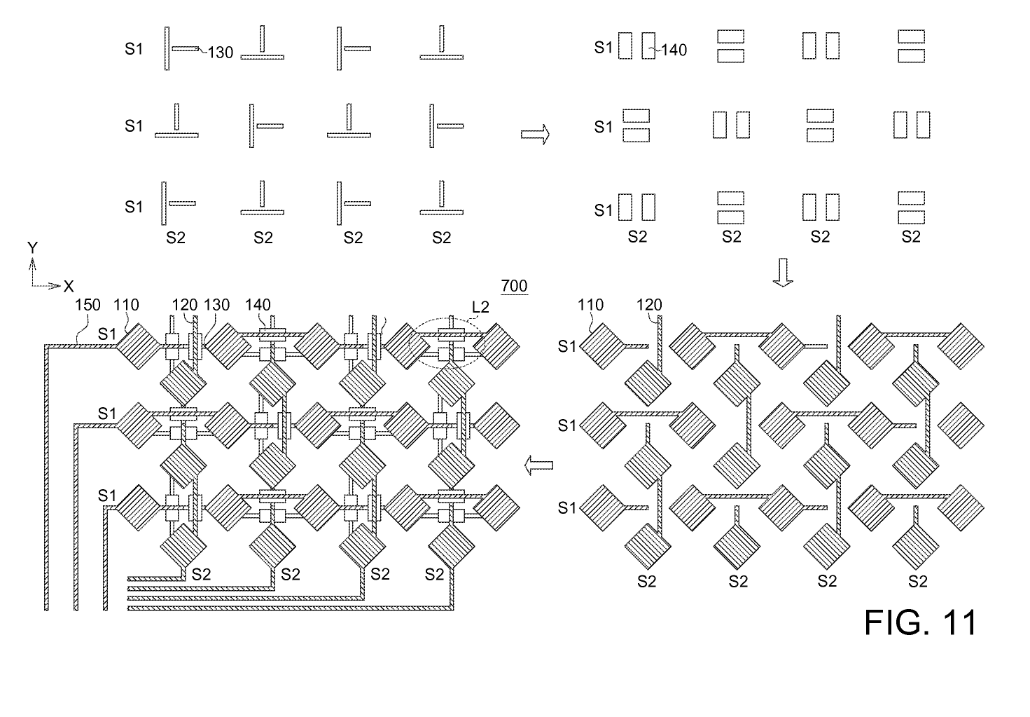

FIG. 11 shows a schematic diagram of a touch panel 700 according to another embodiment of the present invention. A main difference between the touch panel 700 in FIG. 11 and the touch panel 600 in FIG. 10 is the arrangement of the dual-line structures L2, and other similarities are omitted herein.

As shown in FIG. 11, the dual-line structures L2 are uniformly distributed on the entire touch panel 700. The quantities of the dual-line structures L2 of the circuits S1 and the circuits S2 are the same to provide better uniformity. The dual-line structures L2 are arranged in a knitting layout to achieve an impedance matching balance. That is to say, the dual-line structures L2 are staggered on the circuits S1 or the circuits S2 to achieve a balance in overall impedance.

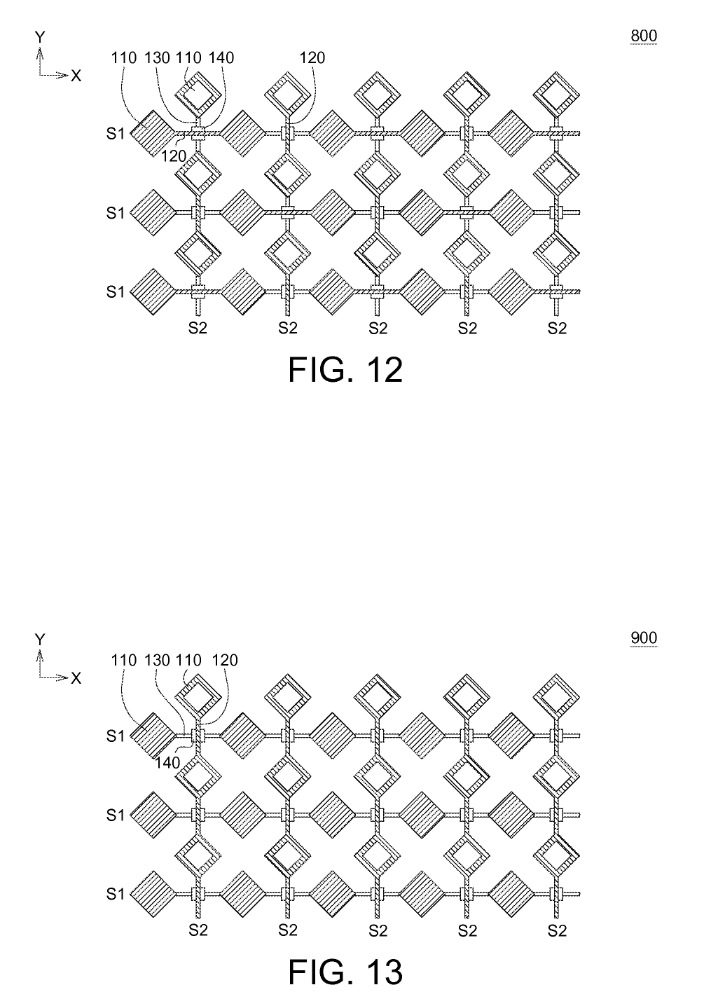

FIG. 12 shows a schematic diagram of a touch panel 800 according to another embodiment of the present invention. A main difference between the touch panel 800 in FIG. 12 and the touch panel 400 in FIG. 8 is the structure of the sensing units 110, and other similarities are omitted herein.

A pattern of the sensing units 110 may be altered to adjust the impedance value. A part of the sensing units 110 may be solid structures or hollow structures. For example, the sensing units 110 located at the circuits S1 may be solid structures, whereas the sensing units 110 located at the circuits S2 may be hollow structures.

As shown in FIG. 12, the solid sensing units 110 are capable of reducing the impedance of the circuits S1, whereas the hollow sensing units 110 are capable of increasing the impedance of the circuits S2. As such, the impedance difference between the circuits S1 and the circuits S2 can be adjusted.

FIG. 13 shows a schematic diagram of a touch panel 900 according to another embodiment of the present invention. A main difference between the touch panel 900 in FIG. 13 and the touch panel 800 in FIG. 12 is the arrangement of the bridge wires 130, and other similarities are omitted herein.

The bridge wires 130 in FIG. 12 are arranged in a knitting layout. In FIG. 13, all of the bridge lines 130 are arranged at the circuits S1 to further reduce the impedance of the circuits S1. As such, the impedance difference between the circuits S1 and the circuits S2 can be adjusted.

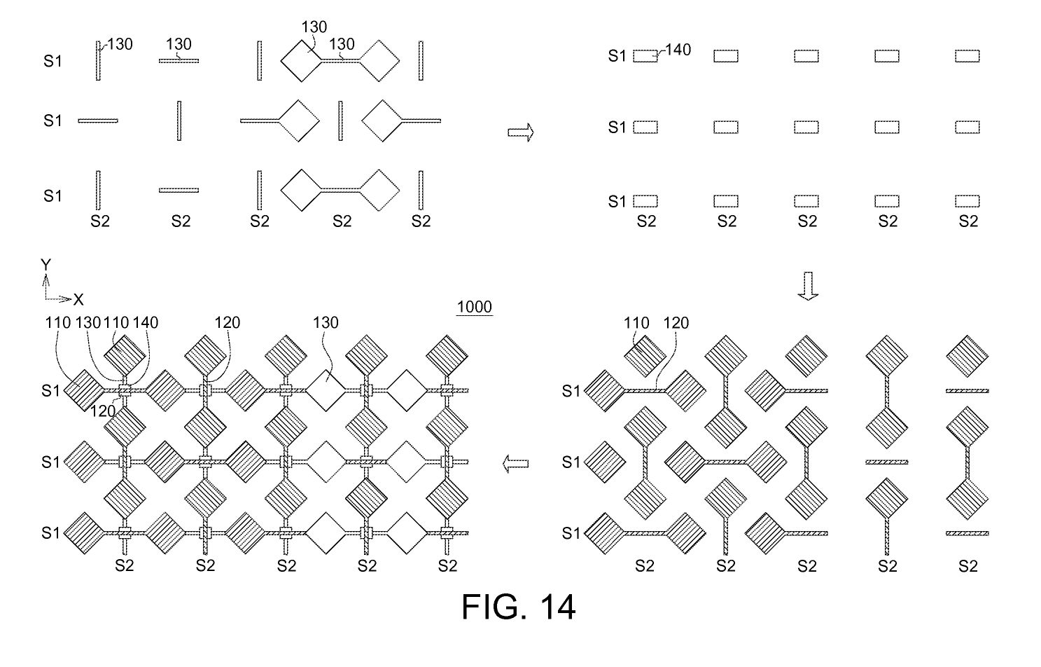

FIG. 14 shows a schematic diagram of a touch panel 1000 according to another embodiment of the present invention. A main difference between the touch panel 1000 in FIG. 14 and the touch panel 400 in FIG. 8 is the structure of the bridge wires 130, and other similarities are omitted herein.

As shown in FIG. 14, in addition to being long strip-like structures, for example, given the shape of a part of the bridge wires is different from that of another part of the bridge wires, the bridge wires 130 may also be combinations of rhombus structures and long strip-like structures. The rhombus sensing units 110 are replaced by the rhombus bridge wires 130 to further reduce impedance. In the circuits S1, the rhombus bridge wire 130 may be arranged at the end position to improve the impedance difference between the start position and the end position of the circuits S1, thereby providing the same circuits S1 with uniform impedance. It should be noted that, as the area of a rhombus structure or other expanded shapes is larger than that of a long strip-like structure, the effect for adjusting the impedance can be emphasized.

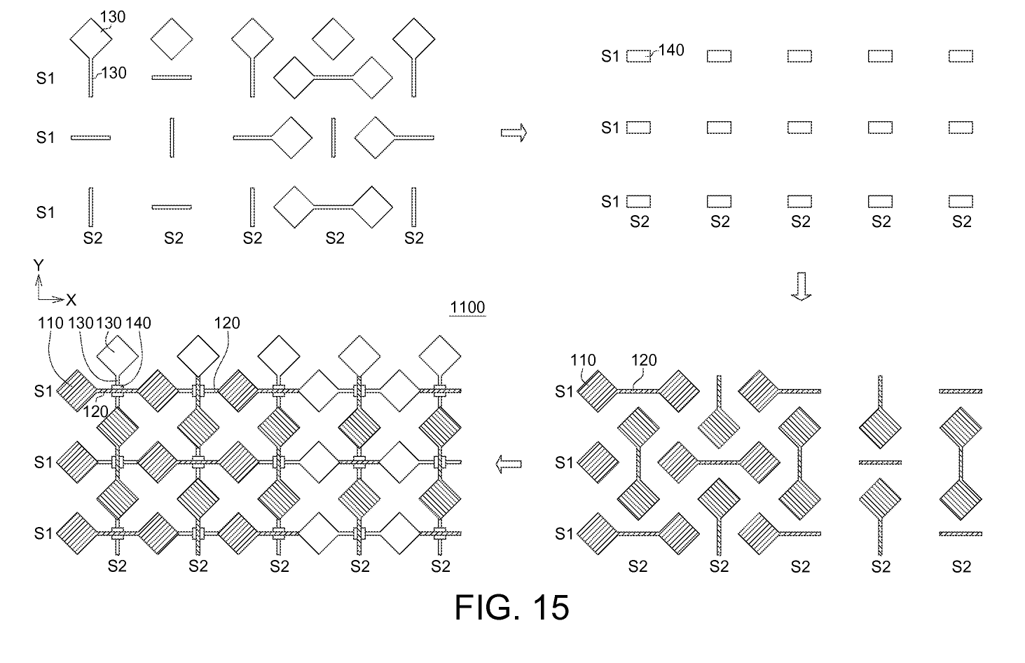

FIG. 15 shows a schematic diagram of a touch panel 1100 according to another embodiment of the present invention. A main difference between the touch panel 1100 in FIG. 15 and the touch panel 1000 in FIG. 14 is the arrangement of the bridge wires 130, and other similarities are omitted herein.

The rhombus sensing units 110 are replaced by the rhombus bridge wires 130 to reduce the impedance. In the circuits S1, the rhombus bridge wire 130 may be arranged at the end position to improve the impedance difference between the start position and the end position of the circuits S1, thereby providing the same circuits S1 with uniform impedance. In the circuits S2, the rhombus bridge wire 130 may be arranged at the end position to improve the impedance difference between the start position and the end position, thereby providing the same circuits S2 with uniform impedance.

With the above embodiments, the impedance difference between different circuits S1, the impedance difference between different circuits S2, the impedance difference between the start position and the end position of the same circuits S1, and the impedance difference between the start position and the end position of the same circuits S2 can be improved.

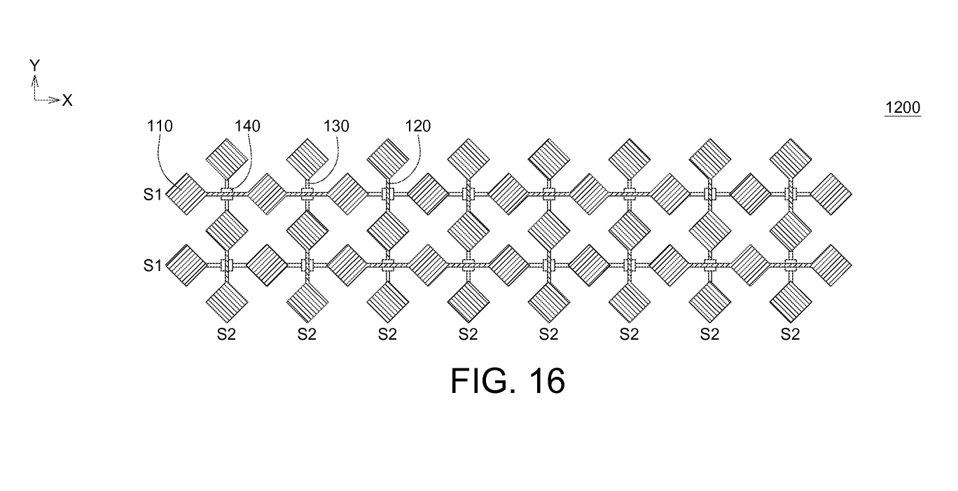

FIG. 16 shows a schematic diagram of a touch panel 1200 according to another embodiment of the present invention. A main difference between the touch panel 1200 in FIG. 16 and the touch panel 400 in FIG. 16 is the arrangements of the connecting wires 120 and the bridge wires 130, and other similarities are omitted herein.

As shown in FIG. 16, the connecting wires 120 and the bridge wires 130 are repetitively arranged according to a predetermined rule, and the impedance of the circuits S1 or the circuits S2 may be adjusted by collaborating with the impedance of different sensing units 110. For example, in FIG. 16, two columns of connecting wires 120 are arranged for every other two columns, and two columns of bridge wires 130 are similarly arranged for every other two columns. The connecting wires 120 and the bridge wires 130 are not limited to being arranged for every two other columns or to a regular arrangement. For example, in an alternative embodiment, the connecting wires 120 and the bridge wires 130 may be arranged for every other three columns or arranged in three columns. That is to say, two neighboring bridge wires 130 are regarded as one group, and the bridge wires 130 of two neighboring groups are extended toward the first direction and the second direction respectively. In yet another embodiment, the connecting wires 120 and the bridge wires 130 may also be arranged according to a random-number rule. For example, a larger number of bridge wires 130 may be arranged at a position with higher impedance, and a larger number of connecting wires 120 can be arranged at a position with lower impedance. That is to say, the bridge wires 130 are staggered at the circuits S1 or the circuits S2, and the connecting wires 120 are also staggered at the circuits S1 or the circuits S2 at the same time, thereby achieving a balance in overall impedance.

It should be noted that, the quantities of the circuits in the above embodiments are examples for illustration purposes, not limitations to the present invention. Further, the circuits on the touch panel may adopt alternative designs other than the above examples. Further, in the above embodiments, the impedance value of the bridge wires is smaller than the impedance value of the connecting wires as an example. However, by utilizing a smaller number of bridge wires instead of a previously larger number of bridge wires and a larger number of connecting wires instead of a previously smaller number of connecting wires, the impedance value of the bridge wires can be rendered to be larger than the impedance value of the connecting wires, thereby also achieving the object of adjusting the impedance.

Further, in the above embodiments, the bridge wires 130 and the insulating wires 140 are sequentially manufactured, and then the connecting wires 120 and the sensing units 110 are simultaneously manufactured. It can be appreciated by a person having ordinary skill in the art that, variations may be made to the above embodiments. For example, the connecting wires 120 and the sensing units 110 may be manufactured first (separately or simultaneously), then the insulating layers 140 is formed to stack on the connecting wires 120, and afterwards the bridge wires 130 is formed.

Further, at least one of the bridge wires 130, the connecting wires 120 and the sensing units 110 can be two-layer structure of a high-impedance material (e.g., ITO) and a low-impedance material (e.g., a metal). For another example, the sensing units 110 may be a three-layer stack of ITO/Ag/ITO.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch panel, comprising:
a plurality of sensing units, a part of the sensing units being arranged along a first direction, another part of the sensing units being arranged along a second direction;
a plurality of connecting wires; and
a plurality of bridge wires, a part of the connecting wires and a part of the bridge wires being connected to the part of the sensing units along the first direction, another part of the connecting wires and another part of the bridge wires being connected to the another part of the sensing units along the second direction, an impedance value of each bridge wire being different from that of each connecting wire.

2. The touch panel according to claim 1, wherein the impedance value of each bridge wire is lower than that of each connecting wire.

3. The touch panel according to claim 1, wherein a material of each connecting wire is same as that of each sensing unit.

4. The touch panel according to claim 3, wherein the connecting wires and the sensing units are formed integrally.

5. The touch panel according to claim 1, wherein a length of each of the part of the bridge wires is smaller than that of each of the another part of the bridge wires.

6. The touch panel according to claim 1, wherein a length of each of the part of the connecting wires is smaller than that of each of the another part of the connecting wires.

7. The touch panel according to claim 1, further comprising a plurality of lead wires respectively connected to the part of the sensing units, the lead wires having different impedance values, wherein the number of the bridge wires connected to the lead wires are different.

8. The touch panel according to claim 1, wherein two neighboring bridge wires among the bridge wires are extended toward the first direction and the second direction respectively.

9. The touch panel according to claim 1, wherein every two neighboring bridge wires are regarded as one group and the bridge wires of two neighboring groups are extended toward the first direction and the second direction respectively.

10. The touch panel according to claim 1, wherein one of the connecting wires and one of the bridge wires are arranged into a dual-line structure that connects to two neighboring sensing units.

11. The touch panel according to claim 1, wherein one of the connecting wires and one of the bridge wires are connected to be a single-line structure that connects to two neighboring sensing units.

12. The touch panel according to claim 1, wherein the part of the sensing units are solid structures, and another part of the sensing units are hollow structures.

13. The touch panel according to claim 1, wherein a shape of each of the part of the bridge wires is different from that of each of the another part of the bridge wires.

14. The touch panel according to claim 1, further comprising a substrate, the sensing units, the connecting wires and the bridge wires being disposed at a same side of the substrate.

15. The touch panel according to claim 14, wherein the substrate is a cover lens.

16. The touch panel according to claim 14, wherein the substrate is a component of a display device.

17. The touch panel according to claim 16, wherein the substrate is a color filter (CF) of a liquid crystal display (LCD) display.

18. The touch panel according to claim 16, wherein the substrate is an encapsulation cover of an organic light-emitting diode (OLED) display.

19. The touch panel according to claim 1, wherein at least one of the bridge wires, the connecting wires and the sensing units is a metal mesh.

20. The touch panel according to claim 1, wherein at least one of the bridge wires, the connecting wires and the sensing units is a multi-layer structure.

21. The touch panel according to claim 20, wherein at least one of the bridge wires, the connecting wires and the sensing units comprises a stack of indium tin oxide (ITO) and metal.
